(19) United States
(12) Patent Application Publication
(10) Pub. No.: US 2021/0045374 A1
(43) Pub. Date: Feb. 18, 2021

(54) HOOF TAP DEVICE

(71) Applicant: DOUGLAS GERARD EHRMANN, CHESTER, NY (US)

(72) Inventor: DOUGLAS GERARD EHRMANN, CHESTER, NY (US)

(21) Appl. No.: 16/768,308

(22) PCT Filed: Nov. 30, 2017
(86) PCT No.: PCT/GB2017/053623

§ 371 Date: May 29, 2020

(51) Int. Cl. A01L 3/00; A01K 29/00

(52) U.S. Cl. CPC A01L 3/00; A01K 29/005

(57) ABSTRACT

A hoof tap device (10) including: a tap bridge (14) providing a back edge (30); and one or more, e.g. a plurality of, tap posts (12) extending from the tap bridge, in a direction away from the back edge, wherein the tap bridge is dimensioned and adapted to protrude from a portion of a horse hoof wall.

The present invention relates to horseshoes and, more particularly, to an improved horseshoe-like device which allows for proper expansion of the hoof when the hoof hits the ground.

The purpose of horseshoes is to provide protection against excessive and/or uneven wear of the hoof, and against cuts, bruises, and other injuries thereto, as well as providing better traction as compared to a shoeless horse's hoof. However, horseshoes tend to interfere with the natural mechanical functioning of the horse's hoof, which tend to expand when the hoof hits the ground with each step, thereby providing a form of shock absorption, reducing strain on the horse's muscles and tendons.

A horseshoe, in order to provide the above mentioned benefits of a barrier and traction device, are necessarily rigid. Being a rigid barrier rigidly fixed to the hoof, however, between the ground and the horse's hoof, does not allow for proper expansion of the hoof when the hoof hits the ground, thereby restricting natural movement of the hoof. Alternative horse boots have been offered as a solution, but such horse boots can be loose, cumbersome, and sometime difficult to put on and keep on.

As can be seen, there is a need for a hoof tap device for the protection a horse's' hoof, ideally while facilitating the natural movement and expansion of the hoof as the horse steps.

One aspect provides a hoof tap device including: a tap bridge providing a back edge; and one or more, e.g. a plurality of, tap posts extending from the tap bridge in a direction away from the back edge, wherein the tap bridge is dimensioned and adapted to protrude from a portion of an animals hoof, e.g. a hoof wall.

The hoof tap device may provide for the protection an animal's hoof, while facilitating the natural movement and expansion thereof.

The animal may be an equine, e.g. a horse, a donkey or a mule.

The tap post(s) may extend transversely from the tap bridge. The tap post(s) may extend from an edge f the tap bridge opposite the back edge.

In embodiments comprising a plurality of tap posts, the tap posts may be parallel with each other.

The or each tap post may have a piercing tip disposed at or near a distal end. The or each piercing tip may have any suitable shape. For instance, the or each piercing tip may have the form of an arrowhead. The or each piercing tip may be generally triangular or conical in form.

The hoof tap device may comprise at least one tap tooth extending away from the tap bridge in a direction away from the back edge. For instance, a given tap tooth may be disposed between two adjacent tap posts.

The hoof tap device may include: a tap bridge providing a back edge; a plurality of tap posts transversely extending from the tap bridge, wherein the plurality of tap posts is opposing the back edge; a triangular piercing tip disposed along a distal end of each of the plurality of tap posts; and a tap tooth disposed between two adjacent tap posts of the plurality of tap posts, wherein the tap bridge extends for approximately 2.86 cm (1.125 inches) and each f the plurality if tap posts extends for approximately 1.11 cm (0.4375 inches) from the tap bridge to its respective distal end so that the tap bridge is dimensioned and adapted to protrude front a portion of a horse hoof wall.

Another aspect provides a method of protecting an animal's hoof from excessive wear when the animal steps, while enabling proper expansion of the hoof at the same time, includes the steps of providing one or more. e.g. a plurality, of the above-mentioned hoof tap devices and inserting the hoof tap device(s) into the animal's hoof such that a portion of each back edge protrudes from a bottom of the hoof.

The hoof Lap device(s) may be inserted just inward of a hoof wall of the hoof. When a plurality of hoof tap devices are inserted into the animal's hoof, the hoof tap devices may be regularly or irregularly spaced apart.

The hoof tap device may provide additional traction, may stop excessive wear without the use of a full horse shoe, may improve the movement of the hoof by allowing the hoof to flex and expand naturally, and/or, in some cases, may provide correction of the hoof.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined With any other feature described herein.

These and other features, aspects and advantages of the present disclosure will become better understood with reference to the following drawings, description and claims.

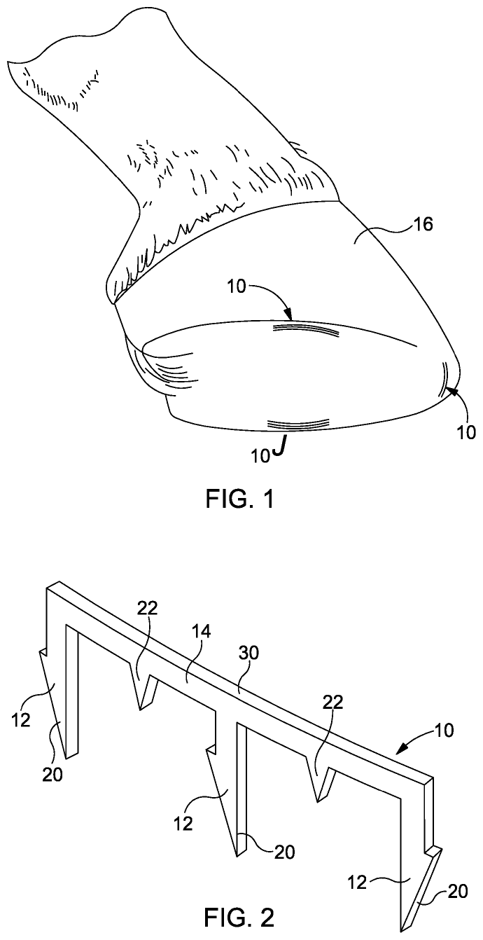

FIG. 1 is a perspective view of an exemplary embodiment of the present invention, shown in use;

FIG. 2 is a front perspective view of an exemplary embodiment of the present invention;

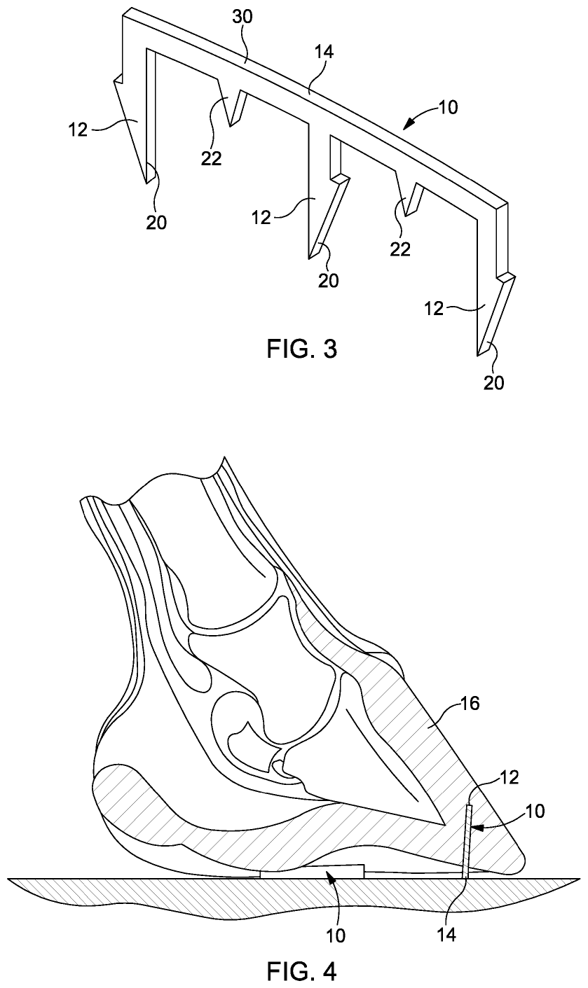

FIG. 3 is a rear perspective view of an exemplary embodiment of the present invention; and

FIG. 4 is a section view of an exemplary embodiment of the present invention, taken along line 4-4 of FIG. 1;

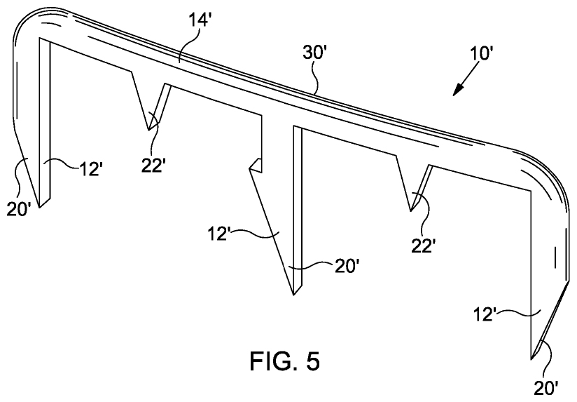

FIG. 5 is a perspective view of another embodiment of the invention.

Broadly, an embodiment of the present invention provides a hoof tap device, wherein each hoof tap device has a tap bridge from which one or more; e.g. a plurality of, tap posts extend in a direction away from the back edge, wherein the tap bridge is dimensioned and adapted to protrude from a portion of a horse hoof wall.

The hoof tap device may enable traction, prevent excessive wear, and/or improve the movement of the hoof by allowing it to flex and expand naturally during use.

Referring to FIGS. 1 through 4, the present invention may include a hoof tap device 10. Each hoof tap device 10 may provide a tap bridge 14 extending between a plurality of, e.g. three, tap posts 12. Each hoof tap device 10 can be made in different sizes with different materials, including stainless steel, titanium, or other sufficiently strong and durable materials. Each hoof tap device 10 can be laser cut or stamped from solid sheet of hard metal, plastic, or the like. The hoof tap device 10 may also be molded.

In certain embodiments, a continuous back edge 30 may be shared and/or defined by the tap bridge 14 and the tap posts 12. Each tap post 12 may have a piercing tip 20 at its distal end. Each piercing tip 20 may be triangular. Between two tap posts 12 may be a smaller tap tooth 22.

The small size of the hoof tap device 10 enables a user. e.g. a farrier, to selectively place a plurality of hoof tap devices 10, spaced apart just inward of the hoof wall 16 of the hoof 18, whereby the tap posts 12 extend into the hoof 18 so that at least a portion of the tap bridge 14 or back edge 30 protrudes from the hoof 18, as illustrated in FIGS. 1 and 4, enabling the hoof 18 to have natural movement. The hard material of the protruding hoof tap device 10 helps to stop excessive wear and also enables traction and grip.

Each hoof tap device 10 may extend approximately 2.86 cm (1.125 inches) in length from end to end.

Each tap post 12 may extend approximately 1.11 cm (0.4375 inches) from the back edge 30 to its distal end. If necessary-; the dimensions of the hoof tap device 10 can be changed to accommodate differently sized animals and purposes.

A method of using the present invention may include the following. A hoof tap device 10 disclosed above may be provided. A user may insert a plurality of hoof tap device 10, spaced apart just inward of the hoof wall 16 of the hoof 18 so that at least a portion of the back edge 30 protrudes therefrom. The hoof tap device 10 would protect the horses hoof 18 and, in certain embodiments, also be used to correct issues in the hoof and it's movement Because it is not a full horse shoe that encompasses the whole foot, the hoof tap device 10 allows for natural movement of the hoof 18 itself while protecting and preserving the wall 16 and sole of the horse's hoof 18.

FIG. 5 is a perspective view of a hoof tap device 10′ according to another exemplary embodiment of the invention. The hoof tap device 10′ is similar to that illustrated in FIGS. 1 to 4 and described above. Like reference numerals are used to indicate like features, except with the addition of a prime.

The hoof tap device 10′ may provide a tap bridge 14′ extending between a plurality of, e.g. three, tap posts 12′. Each hoof tap device 10′ can be made in different sizes with different materials, including stainless steel, titanium, or other sufficiently strong and durable materials. Each hoof tap device 10′ can be laser cut or stamped from solid sheet of hard metal, plastic, or the like. The hoof tap device 10′ may also be molded.

In certain embodiments, a continuous back edge 30′ may be shared and/or defined by the tap bridge 14′ and the tap posts 12″. Each tap post 12′ may have a piercing tip 20′ at its distal end. Each piercing tip 20′ may be triangular. Between two tap posts 12′ may be a smaller tap tooth 22′. The tap bridge 14′, in particular the back edge 30′ thereof, is rounded or bevelled.

The hoof tap device 10′ may be used in the same way as described above in respect of the hoof lap device 10.

The hoof tap device may be made from any sufficiently hard material. The material may comprise, or consist essentially of, a metal, a polymer, a composite or a ceramic.

The hoof tap device may be made from a metal, e.g. an alloy such as a steel. The metal may be hardened before or after the hoof tap device is formed (e.g. stamped or cut) into its final shape.

Suitable metals may include a stainless steel, a zinc-coated steel (e.g. a galvanised steel), titanium or a nickel alloy. The steel may comprise a hardened spring steel.

The metal may be rust resistant. Use of a zinc-coated steel (e.g. a galvanised steel) may confer an additional benefit, in that zinc can naturally kill bacteria. For instance, zinc could kill the bacteria that cause infection in the animal's hoof. Zinc could kill the bacteria that causes white line disease.

The hoof tap device may comprise any number of tap posts. For instance, the hoof tap device may comprise ne, two, three, four, five, six, seven, eight, nine or 10 tap posts. The hoof tap device may comprise up to 20 tap posts, up to 10 tap posts or up to five tap posts. The tap posts may be spaced at regular or irregular intervals along the tap bridge.

The piercing tip(s) may have any suitable form.

The hoof tap device or a portion thereof may be treated, e.g. coated or impregnated, with an antimicrobial agent and/or an antibacterial agent.

The hoof tap device may be manufactured by cutting or stamping the hoof tap device from a solid sheet or roll of material.

The hoof tap device may be manufactured as a single piece. The tap bridge, tap post(s), and tap tooth or teeth if present, may be be formed as a single piece.

The hoof tap device may be provided with a chip operable to monitor and optionally transmit data. The data may relate to one or more of: the movement of the animal, the location of the animal; and/or wear of the hoof tap device.

The chip may be operable to transmit a signal to inform a user that the hoof tap device should be, or should soon, be replaced. For instance, the chip may be operable to transmit the signal after a predetermined time period and/or when a predetermined amount of wear of the hoof tap device has occurred.

The hoof tap device may have any suitable size and shape. For instance, the tap bridge may have a length of at least 0.5 cm or at least 1 cm and/or up to 11) cm or up to 15 cm.

The tap pots may have any suitable length. The tap posts may have a length of up to 5 cm, up to 3 cm or up to 1.5 cm.

The tap bridge may be curved at least in part.

The hoof tap device may have a c-shape similar to a full horseshoe shape.

The present invention can be used with other hoofed animals, e.g. equines such as horses, donkeys or mules.

Further advantages of the invention may include:
versatility, in that a given hoof tap device (or hoof tap devices) could be used on animals having a relatively wide range of hoof sizes;
more efficient transport, storage and inventory management, in that the hoof tap device may be relatively light and small compared with traditional horseshoes and nails;
reduced pain or discomfort for the hooved animal, e.g. horse, in comparison to use of a traditional horseshoe on the one hand or to use of no horseshoe n the other.
quicker fitting on a hooved animal in comparison to the fitting of a traditional horseshoe;
increased utilisation of, and reduced discomfort for, the hooved animal, since it is not generally possible for the hoof tap device to fall out inadvertently, unlike with use of traditional horseshoes, where a horse can “throw a shoe”.

It should be understood, of course, that the foregoing relates to exemplary embodiments of the invention and that modifications may be made without departing from the scope of the invention as set forth in the following claims.

1. A hoof tap device including: a tap bridge providing a back edge; and one or more tap posts extending from the tap bridge in a direction away from the back edge, wherein the tap bridge is dimensioned and adapted to protrude from a portion of an animal's hoof.

2. The hoof tap device according to claim 1, wherein the tap post(s) extend transversely from the tap bridge and/or extend from an edge of the tap bridge opposite the back edge.

3. The hoof tap device according to claim 1, wherein the or each tap post has a piercing tip disposed at or near a distal end.

4. The hoof tap device according to claim 1, comprising at least one tap tooth disposed extending from the tap bridge in a direction away from the back edge.

5. The hoof tap device according to claim 1 comprising, or consisting essentially of, a metal, a polymer, a composite or a ceramic.

6. The hoof tap device according to claim 5, wherein the metal includes a stainless steel, a zinc-coated steel, a galvanised steel, a spring steel, titanium or a nickel alloy.

7. The hoof tap device according to claim 1 comprising up to 20 tap posts.

8. The hoof tap device according to claim 1, comprising a plurality of tap posts, wherein the tap posts are spaced at regular or irregular intervals along the tap bridge.

9. The hoof tap device according to claim 1, wherein the hoof tap device or a portion thereof is treated with an antimicrobial agent and/or an antibacterial agent.

10. The hoof tap device according to claim 1, wherein the hoof tap device is provided with a chip operable to monitor data.

11. The hoof tap device according to claim 15, wherein the chip is operable to transmit a signal to inform a user that the hoof tap device should be, or should soon, be replaced.

12. The hoof tap device according to claim 1, wherein the tap bridge is curved at least in part.

13. The hoof tap device according to claim 1, wherein the hoof tap device has a c-shape similar to a full horseshoe shape.

14. A method of protecting an animal's hoof from excessive wear when the animal steps, while enabling proper expansion of the hoof at the same time, includes the steps of providing one or more, e.g. a plurality, of the hoof tap devices according to claim 1 and inserting the hoof tap device(s) into the animal's hoof such that a portion of each back edge protrudes from a bottom of the hoof.

15. The hoof tap device according to claim 10, wherein the chip is operable to transmit data.
